(19) United States
(12) Patent Application Publication
(10) Pub. No.: US 2025/0288971 A1
(43) Pub. Date: Sep. 18, 2025

(54) Heavy Metal and Hydrocarbon Filter and Methods of Use

(71) Applicant: Ertec Environmental Systems, Alameda, CA (US)

(72) Inventors: Richard Sherratt, Alameda, CA (US); Tony Drake, McClellan Park, CA (US)

(73) Assignee: Ertec Environmental Systems, Alameda, CA (US)

(21) Appl. No.: 19/082,082

(22) Filed: Mar. 17, 2025

Related U.S. Application Data
(60) Provisional application No. 63/566,257, filed on Mar. 16, 2024.

(51) Int. Cl. B01J 20/28; B01J 20/10; B01J 20/12; B01J 20/14; B01J 20/18; C02F 1/28; C02F 101/10; C02F 101/20; C02F 101/32; C02F 103/00

(52) U.S. Cl. CPC B01J 20/2805; B01J 20/103; B01J 20/12; B01J 20/14; B01J 20/18; C02F 1/288; C02F 1/281; C02F 1/285; C02F 1/286; C02F 2101/106; C02F 2101/20; C02F 2101/32; C02F 2103/001

(57) ABSTRACT

Mixed media tube or sock filters of variable length with mixed media designed to remove heavy metals and hydrocarbon contaminants, inter alia. The filters of the present invention can be used to control sediment in run-off from a construction site, as drain covers, or as retaining members for lawns or planting areas. A number of or a continuous length of such tube filters can be joined together to form assemblies which are useful for protecting a drain, series of drains, or other water mass, for example a pond or riverbank. Such tube filters can be synergistically joined with other environmental protection approaches, including but not limited to wattles such as ERTEC ProWattle https://ertecsystems.com/products/perimeter-sediment-control-four-types/prowattle-perimeter-control/, top guards such as Top Guard Drain Inlet Protection https://ertecsystems.com/products/top-guard-drain-inlet-protection/, curb guards such as Curb Inlet Guard https://ertecsystems.com/products/top-guard-drain-inlet-protection/curb-inlet-guard/, grate guards such as GR8 Guard https://ertecsystems.com/products/top-guard-drain-inlet-protection/gr8-guard/, and slot guards such as https://ertecsystems.com/products/top-guard-drain-inlet-protection/slot-guard/.

### BACKGROUND OF THE INVENTION

This invention relates to assemblies and methods for mitigation of contaminants in water using a composite granular filtration media containing a mixture of filter media. Generally, the contaminants in the water can be categorized into chemical contaminants and biological contaminants. As water pollution is increasing in occurrence, the potential health and safety issues associated with the chemical contaminants in the water is becoming a more prominent global concern. Some examples of the chemical contaminants include toxic anions (nitrate, nitrite, cyanide, phosphate, perchlorate, and fluoride), as well as anionic metal complexes (chromate, arsenate/arsenite, vanadate and selenate/selenite); metals; heavy metals (lead, mercury, cadmium, zinc, copper, chromium, etc.); synthetic or natural organic matters and hydrocarbons; etc. It is well known that most of the heavy metals and hydrocarbons are toxic to human beings and other living organisms and should be removed from water that may come in contact with such living organisms.

### SUMMARY OF THE INVENTION

In a first aspect, this invention provides a tube or sock made of porous material and filled with a plurality of granular filter media, such plurality of filter media is preferably a combination of adsorbents, for example, one or more zeolites and one or more diatomaceous earth and diatomites. The tube or sock size is adaptable to the application and, pragmatically, has a substantially concentric diameter along the tube length, wherein the diameter is from about 0.5″ to about 12″, preferably from about 1″ to about 6″, most preferably from about 2.5″ to about 4″. The length of the porous, flexible casing in the shape of a tube or sock can be adapted for the application and purpose wherein the length is sufficient to substantially enclose the perimeter of a drain at least one time to prevent channeling or breakthrough without contacting the media filled tube. Said filter media is preferably of a substantially similar particle size preferably in the range of about 100 to about 2000 microns, though may be smaller or larger as long as the particles remain within the tube and may be porous or non-porous media. The tube or sock material is porous to allow liquid, such as contaminated water, to penetrate the tube or sock such that the liquid flows through said tube or sock, contacting said filter media to simultaneously remove contaminants, such as heavy metals (cadmium, lead, mercury, and selenium) and hydrocarbons (gas, diesel, oil), before entering a drain in the road, parking lot, driveway, or the like while allowing for the filtered water to flow, trapping and excluding coarse sediments. The mixed granular filter media filled tube or sock may be used alone to substantially surround from, enclose from or intercede between contaminated fluid or water and one or more drain openings such that the contaminated fluid is at least partially channeled through the tube or sock, contacting said filter media and removing at least some contaminants from said contaminated fluid or water prior to contacted the opening of said drain. The filter can be tailored to mitigate site specific contaminants found in hazardous sites or post-fire recovery zones, such as arsenic, fluoride, phosphorus, atrazine, nitrogen and nitrites.

In a second aspect, this invention provides said tube or sock as described above, wherein the tube or sock is combined with, connected with or attached to a drain cover assembly, such as a drain inlet sediment filter such as GR8 Guard or other Top Guard Drain Inlet Protection by Ertec Environmental Systems. Said tube or sock is preferably detachably connected to said sediment filter surface, for example, though use of Velcro or the like attached to at least one side of said tube or sock to contact the surface material of the sediment filter to integrate the tube or sock filter with the sediment filter. In a preferred approach, the tube or sock forms a natural berm around the sediment filter, resulting in less bulk over the drain itself. Alternatively, said tube or sock filter may be affixed or fastened to the sediment filter using mechanical fasteners. In a preferred embodiment, the tube or sock filter attaches to a fibrous geotextile perimeter gasket through the use of Velcro or the like attached to the tube or sock filter. The filter integrates synergistically with drain inlet production products, including GrateGuard, Curb Inlet Guard, ComboGuard, Hard Surface Guard, and S-Fence, all of which are incorporated herein by reference in their entirety for all purposes.

Preferred combinations include but are not limited to wattles such as ERTEC ProWattle https://ertecsystems.com/products/perimeter-sediment-control-four-types/prowattle-perimeter-control/, top guards such as Top Guard Drain Inlet Protection https://ertecsystems.com/products/top-guard-drain-inlet-protection/, curb guards such as Curb Inlet Guard https://ertecsystems.com/products/top-guard-drain-inlet-protection/curb-inlet-guard/, grate guards such as GR8 Guard https://ertecsystems.com/products/top-guard-drain-inlet- protection/gr8-guard/, and slot guards such as https://ertecsystems.com/products/top-guard-drain-inlet-protection/slot-guard/The filter may be used standalone or connected to form a continuous line or formed into a wide variety of shapes to optimize filtration.

In an embodiment of an aspect of the invention, the mixed media tube filter is affixed to a drain cover assembly, wherein the amount of media is from about 0.25 lb/foot to about 0.75 lb/foot, preferably from 0.4 lb/foot to about 0.6 lb/foot and the length of the mixed media tube filter is from about 100 percent to about 200 percent of the circumference of the drain cover assembly. The mixed media tube filter is adaptable to be useful for protecting a long thin drain, a drain which is rectangular or any shape that allows for the tube filter to bend to the shape around the perimeter of the drain. Alternatively, the tube filter may extend beyond the drain perimeter to achieve the desired mitigation of heavy metals and hydrocarbons and will increase the surface area of media contacting the contaminated liquid.

In an embodiment, the outer sleeve is made from a durable material sufficient to allow for vehicles to run over such tube without substantial damage to the tube.

In another embodiment of an aspect of the invention, the mixed media tube filter may not need to extend to enclose the perimeter where one or more sides form a berm causing the contaminated liquid to flow across less than all side surfaces of the drain. Advantageously, the mixed media tube filter is flexibly adaptable to extend from one side of said berm to the other around the drain surfaces where the contaminated liquid flows across the drain.

### DESCRIPTION OF DRAWINGS

In the drawings, the following numerals are used to denote different components of the assemblies.

FIG. 1 displays an embodiment of the tube or sock filter fixedly engaged with a drain filter.

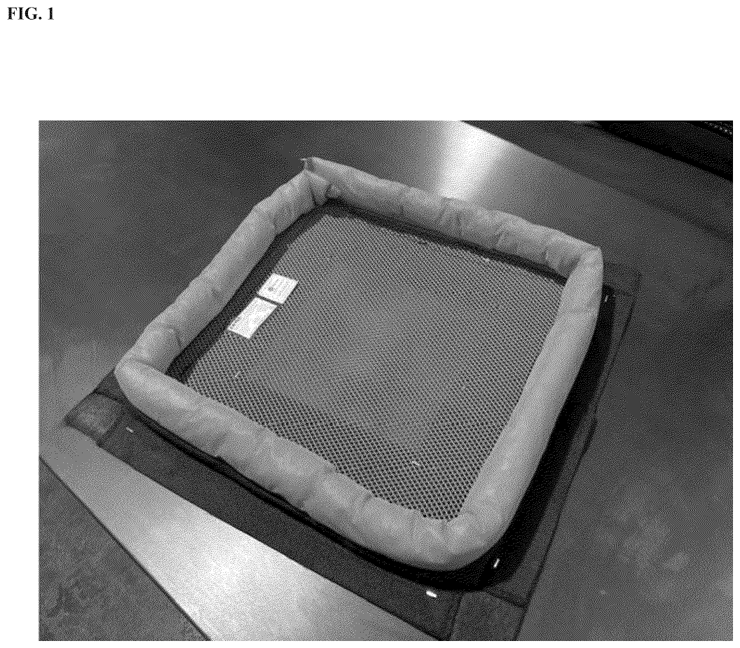

FIG. 2 displays an embodiment of the tube or sock filter.

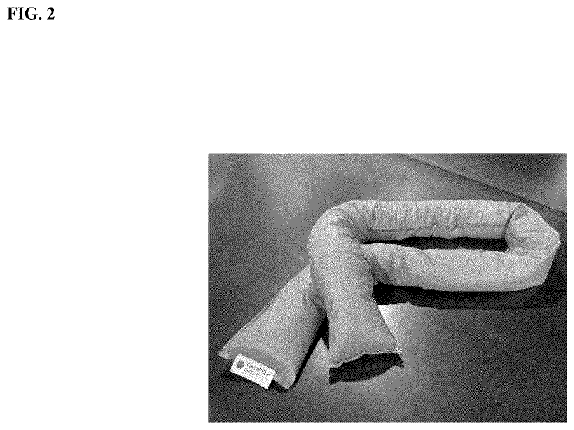

FIG. 3 displays a table of removal of gas and oil using the tube or sock filter described herein.

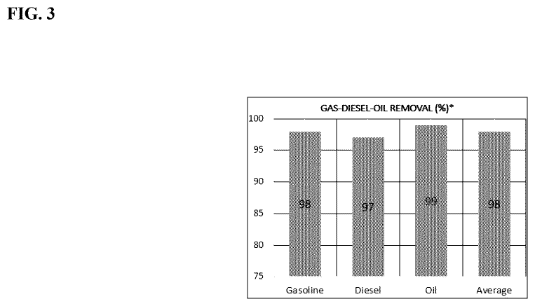

FIG. 4 displays a chart of heavy metal removal by the tube or sock filter described here.

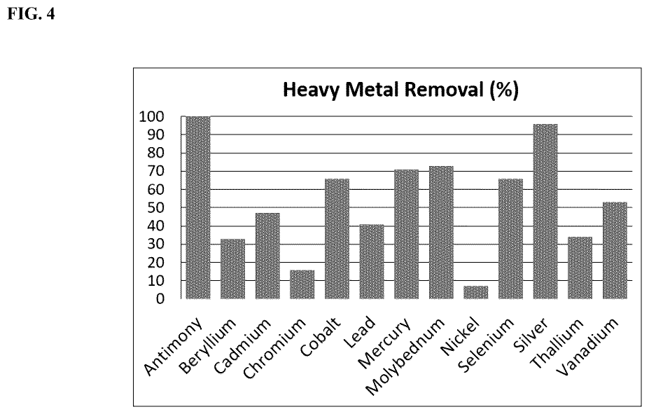

### DETAILED DESCRIPTION OF THE INVENTION

In the Summary of the Invention above, the Detailed Description of the Invention, the Examples, and the claims below, and in the accompanying drawings, reference is made to particular features of the invention, including for example components, ingredients, devices, apparatus, systems, test results and steps, It is to be understood that the disclosure of the invention in this specification includes all possible combinations of such particular features. For example, where a particular feature is disclosed in the context of a particular mode, aspect, embodiment, Figure or claim, that feature can also be used, to the extent possible, in the context of any other particular mode, aspect, embodiment, Figure or claim, and in the invention generally. The invention disclosed and claimed herein includes embodiments not specifically described herein and can for example make use of features which are not specifically described herein but which provide functions which are the same, equivalent or similar to, features specifically disclosed herein.

The term “comprises” and grammatical equivalents thereof are used herein to mean that other features are optionally present. For example, the drain cover assembly defined above which comprises the specified components (A), (B) and (C) can consist of those specified components or can also contain other components, for example the specified components (D) and (E), or other non-specified components. Where reference is made herein to a method comprising two or more defined steps, then, unless the context requires otherwise, the defined steps can be carried out in any order or simultaneously, and the method can include one or more other steps which are carried out before any of the defined steps, between two of the defined steps, or after all the defined steps. The term “at least” followed by a number is used herein to denote the start of a range beginning with that number (which may be a range having an upper limit or no upper limit, depending on the variable being defined). For example “at least 1” means 1 or more than 1, and “at least 80%” means 80% or more than 80%. When, in this specification, a range is given as “(a first number) to (a second number)” or “(a first number)−(a second number)”, this means a range whose lower limit is the first number and whose upper limit is the second number. For example, “0.5-3” means a range whose lower limit is 0.5, and whose upper limit is 3. The numbers given herein should be construed with the latitude appropriate to their context and expression. The terms “plural” and “plurality” are used herein to mean two or more. When reference is made herein to “a”, “an”, “one” or “the” feature, it is to be understood that, unless the context requires otherwise, there can be one or more than one such feature.

Where reference is made herein to two or more components (or parts or portions etc.), it is to be understood that the components can be, unless the context requires otherwise, separate from each other or integral parts of a single structure or a single component acting as the two or more specified components. When reference is made herein to a component being on one side, or at the front, or at the rear, or upwards or downwards, of an assembly, the reference is to the assembly in the horizontal position.

This specification incorporates by reference all documents referred to herein and all documents filed concurrently with this specification or filed previously in connection with this application, including but not limited to such documents which are open to public inspection with this specification.

Where reference is made herein to porous material, all the pores in any particular sheet will generally be of the same size. If they are not, the pore size referred to is the approximate arithmetic average of the different sizes.

Except where the disclosure this specification is at variance with the disclosure in the patents and applications incorporated by reference herein, the disclosure in that patent and those applications is also applicable, mutatis mutandis, to the present invention. For example, the threshold and outflow members, and filter members if present, can be composed of the same materials as those disclosed in U.S. Pat. No. 6,848,866 (in particular at column 4, line 37, to column 7, line 53); the SCDs can comprise a substantially hollow sediment collection chamber as disclosed in U.S. Pat. No. 6,848,866 (particularly at column 2,lines 6-28, and column 8, lines 55-67); the SCDs preferably include a location member, as described in U.S. Pat. No. 6,848,866 (in particular at column 9, lines 10-26); the SCDs can be manufactured as described in U.S. Pat. No. 6,848,866 (in particular at column 10, lines 3-40); and two or more SCDs can be joined end-to-end or side-by-side by the methods disclosed in U.S. Pat. No. 6,848,866 (in particular at column 9, line 27, to column 10, line 2).The SCDs described in U.S. Pat. Nos. 6,848,866 and 7,008,144; U.S. application Ser. Nos. 10/843,010 and 60/569,979 filed May 11, 2004; Canadian application No. 2,469,683;and International application No. PCT/US/042092 are “substantially hollow”, the term “substantially hollow” being used to mean that the SCD comprises a sediment control member (SCC) which has an unobstructed volume which is at least 50%, e.g. 50 to 98%, particularly at least 70%, e.g. 70 to 97%, for example at least 80%, e.g. 80 to 96%, of the total volume of the SCD.

Adsorbents used in the mixed media tube filter are beneficial in the removal of heavy metals and hydrocarbons and can be any mixture including the following in proportions based on the intended contaminants for mitigation:

1. Inorganic Mineral Sorbents;

2. Natural Organic Sorbents; or

3. Synthetic Organic Sorbents (synthetic polymers).

Mineral adsorbents represent a very large group; these are commonly used as they have a number of advantages such as non-flammability, chemical inertness, relatively low cost and easy availability. They can be considered as a group of universal adsorbents. Most mineral adsorbents are raw materials of natural origin which are used in a powder or granular form. Their particle size may range from several nm to several mm. Mineral adsorbents are generally non-combustible and resistant to acids and bases. Usually, their sorption capacity towards petroleum derivatives is in the range 0.20-0.50 g/g, and their bulk density is 0.45-0.90 kg/dm³. Mineral sorbents are allowed to absorb the substance, and are then collected together with the absorbed substance and transferred for recycling.

Natural organic adsorbents used in chemical rescue include peat, needle-cover, moss, dry leaves, straw, sawdust, bark and wood waste, cellulose from paper and cotton products, linen materials, cotton and hemp. The literature also describes other sorbents of natural origin from agricultural and/or processing wastes, such as rice husk, various types of plant shells and plant waste, kapok and many others. Natural organic adsorbents are considered to be effective, inexpensive, easy available and environmentally friendly. They are biodegradable and flammable, and thus are easy to utilize.

The group of synthetic polymers includes polypropylene, polyethylene, polyacrylate, polystyrene, and polyurethane. Polymer adsorbents exhibit hydrophobic properties and large sorption capacity with respect to petroleum derivatives.

### Mineral Adsorbents

### Zeolites

Zeolites are aluminosilicates of the alkaline and alkaline earth metals. The main elements of the crystalline framework of zeolites are [SiO₄]⁴⁻ and [AlO₄]³⁻ tetrahedrons connected by oxygen atoms. These tetrahedrons form three-dimensional lattice with free channels of diameter 0.3-3 nm, which gives these minerals a “molecular sieve” character and sorption properties. A negative charge is created as a consequence of the partial replacement of Si⁴⁺ions by Al³⁺ions in the zeolites' crystal lattice, which is compensated for by Ca²⁺, Na⁺ or K⁺ ions localized in channels where H₂O molecules are also present. The cations are readily replaced by others from the surrounding solution, thus giving rise to the ion exchange capabilities of zeolites. In addition, surface OH groups provide these minerals with acid and sorption properties. From the perspective of their origin, zeolites can be divided into natural (created/formed as a result of geological processes occurring in nature) and synthetic. The synthetic zeolites are usually obtained from the chemical reaction between sodium silicate, Na₂SiO₃, and sodium aluminate, NaAlO₂, under varying conditions of temperature, pressure and reaction time.

### Clay Minerals

Clay minerals cover several groups of hydrous aluminium phyllosilicates. They form in sediments, soils and as the result of the diagenetic and hydrothermal alteration of rocks. Their foundation is formed from [SiO₄]⁴⁻ tetrahedrons, connected at three corners by shared oxygen anions, thus forming the tetrahedral sheet. Divalent or trivalent metal cations (aluminium, magnesium, iron and calcium) are bonded to the tetrahedral sheet, coordinated to one hydroxyl and two oxygen anion groups and surrounded by six oxygens or hydroxyl groups, thus forming the octahedral sheet. Depending on the arrangement of the tetrahedral and octahedral sheets, phyllosilicate ratios of 1:1 (involving units of alternating tetrahedral and octahedral sheets), 2:1 (two tetrahedral and one octahedral sheet) and 2:1:1 (two 2:1 layers with one octahedral sheet between them) can be distinguished. In the structure of clay minerals the interlayer space is occupied by hydrated cations. The most common representatives of various structures of clay minerals are kaolinite, montmorillonite and sepiolite. Clay minerals exhibit many special properties such as sorption capacity, swelling behaviour, and ion exchange capability which result from their unique structure, the presence of surface OH groups and weak electrostatic interactions between the layers/sheets and the exchangeable cations.

### Silica Adsorbents

The group of silica adsorbents includes rocks (siliceous earths, diatomaceous earths, diatomites) and perlite. In terms of their mineral composition, mineraloids dominate this group (opal and chalcedony), with certain amounts of other minerals being present (cristobalite, quartz, clay minerals and carbonates). Opal can occur in a colloidal silica form, with a variable water content (1-21 wt %) which is released in a continuous manner during drying of the mineral. It is an amorphous substance containing a disordered skeleton of [SiO₄]⁴⁻ tetrahedrons with H₂O molecules located in the voids. Opal thus transforms to chalcedony, a semi-crystalline type of quartz. The sorption properties of silica adsorbents result from their significant porosity and the presence of surface hydroxyl groups. These groups are created during the natural formation of opal, and as a result of chemical reactions between the mineral surface and substances present in the environment. Diatomaceous earth and diatomites are formed from the exoskeletons of unicellular algae known as diatoms, which collected at the bottom of water bodies over many millions of years. The exoskeletons of these microorganisms form a unique structure which provides the mineral with a significant contribution of free spaces (between exoskeletons), meso-and macroporosity. Thus, diatomaceous materials are widely used as sorbents of petroleum compounds in the form of oils and vapours of organic compounds including benzene, toluene, ethylbenzene and xylenes (BTEX).

### Modified Mineral Adsorbents

All modifications of mineral adsorbents are aimed at improving their sorption parameters towards particular impurities. These modifications generally include a thermal treatment (calcination, expanding) and the functionalization of the mineral's surface with organic compounds.

Calcinated sorbents (e.g., diatomite) exhibit a more developed specific surface area, a higher sorption capacity (0.50-1.30 g/g) and slightly lower bulk density (0.45-0.60 kg/dm³). Examples of expanded adsorbents are perlite and vermiculite; these are characterized by a low bulk density (approximately 0.25 kg/dm³) and good buoyancy, and they can therefore be applied to remove oils from the surface of water.

The filter may be made in a plurality of configurations.

For example, in integrated for an about 2.5″ diameter×7′ length filter can be attached to standard ERTEC drain inlet protection products. For convenience the filters can be packaged efficiently, a single filter may weigh approximately about 10 lbs to about 20 lbs depending on the fill density or about 1.4 lbs to about 3 lbs per foot length at 2.5″ diameter filter.

A standalone filter may be about 4.0″ in diameter×7′ in length filter can be used as a single unit or daisy chained to form a continuous filter system and preferred weighs about 25 lbs to about 50 lbs depending on the fill density or about 3.5 to about 7.2 lbs per foot length.

Example 1 Shell Characteristics:

| Mechanical | | | Min. Average | |
|---|---|---|---|---|
| Properties | Test Method | Unit | Value | |
| Grab Tensile | ASTM D 4632 | Lbs (kN) | 160 | (0.71) |
| Strength | | | | |
| Grab Tensile | ASTM D 4632 | % | 50 | |
| Elongation | | | | |
| Trapezoid Tear | ASTM D 4533 | Lbs (kN) | 60 | (0.267) |
| Strength | | | | |
| CBR Puncture | ASTM D 6241 | Lbs (kN) | 410 | (1.82) |
| Strength | | | | |
| 160Apparent | ASTM D 4751 | US Sieve (mm) | 70 | (0.212 |
| Opening Size | | | | |
| Permittivity | ASTM D 4491 | Sec (−1) | 1.5 | |
| Flow Rate | ASTM D 4491 | Gal/min/ft\hat{ }2 | 110 | |
| UV Resistance | ASTM D 4355 | % strength | 70 | |
| (500 hrs) | | retained | | |

including but not limited to wattles such as ERTEC ProWattle https://ertecsystems.com/products/perimeter-sediment-control-four-types/prowattle-perimeter-control/, top guards such as Top Guard Drain Inlet Protection https://ertecsystems.com/products/top-guard-drain-inlet-protection/, curb guards such as Curb Inlet Guard https://ertecsystems.com/products/top-guard-drain-inlet-protection/curb-inlet-guard/, grate guards such as GR8 Guard https://ertecsystems.com/products/top-guard-drain-inlet-protection/gr8-guard/, and slot guards such as https://ertecsystems.com/products/top-guard-drain-inlet-protection/slot-guard/

1. A tube filter containing one or more fill materials, wherein the filter is about 2.5″ in diameter and contains a fill amount such that the tube weight is from about 1.4 lbs to about 3 lbs per foot length.

2. A tube filter containing one or more fill materials, wherein the filter is about 4″ in diameter and contains a fill amount such that the tube weight is from about 3.5 lbs to about 7.2 lbs per foot length.
